(19) United States
(12) Patent Application Publication
(10) Pub. No.: US 2002/0163699 A1
(43) Pub. Date: Nov. 7, 2002

(54) Wireless infrared multi-spot diffusing communication system

(75) Inventors: Mohsen Kavehrad, State College, PA (US); Svetla Jivkova, State College, PA (US)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: The Penn State Research Foundation

(21) Appl. No.: 10/079,936

(22) Filed: Feb. 19, 2002

Related U.S. Application Data
(60) Provisional application No. 60/269,501, filed on Feb. 16, 2001.

(51) Int. Cl. H04B 10/00

(52) U.S. Cl. 359/172; 359/154

(57) ABSTRACT

An infrared communications system includes a multi-beam transmitter for producing an array of diffusing spots upon a reflecting surface, and a receiver comprising a plurality of receiving elements, where each receiving element has an independent field of view that is in line of sight of at least one of said diffusing spots. The array may be in the form of a regular grid, and the grid of diffusing spots may be formed via the emission from the transmitter of a plurality of collimated beams of equal intensity. The transmitter may include a light source, collimating optics, and a spot array generator, and each of the receiving elements may include a band-pass filter, a concentrator and a photodetector.

### BACKGROUND OF THE INVENTION

1. Field of the Invention

The present invention relates to wireless infrared systems, and, in particular, to a system with a multiple beam transmitter and one or more multi-branch receivers.

2. Discussion of the Background Art

Two ways of classifying wireless infrared (IR) systems include classifying them according to whether their links are directed or non-directed, or according to whether they rely on a line of sight between the transmitter and receiver.

In a directed link system, a narrow beam transmitter and a narrow field of view receiver are used, where in a non-directed system a broad beam transmitter and a wide field-of-view receiver are typically used. A line of sight system requires an unblocked path between the transmitter and receiver, while a non-line of sight system is functional without such a path.

A directed link line of sight infrared system is very efficient in terms of power consumption and bit rate transmission. In order to achieve these efficiencies, however, tight alignment between the transmitter and receiver is required, as well as immobility of the receiver. Interruptions in transmission in such a system are frequently caused by shadowing, that is, a blocking or deflecting of the infrared beam. A typical directed link line of sight infrared system is shown in FIG. 1.

Some of the disadvantages of the directed line of sight system (i.e. transmitter-receiver alignment, receiver immobility, and shadowing), are overcome by a non-directed non-line of sight system, also referred to as a diffuse system. A diffuse system usually employs a wide beam transmitter and a wide field-of-view receiver and relies on diffuse reflections of a transmitted IR optical signal reflecting from surfaces in the environment such as ceilings, walls, etc. However, these types of systems suffer from ineffective use of power and multipath signal dispersion, which tend to greatly limit the rate of transmission. A typical diffuse system is shown in FIG. 2.

A non-directed line of sight system using a cellular architecture is shown in FIG. 3. This system may employ a wide field-of-view receiver and a broad beam transmitter, thus utilizing the high bit rate capability of a line-of-sight system and the component mobility of a diffuse system. However, in order to achieve a high transmission bit rate, the communication cell diameter has to be relatively small. For example, experimental results show that a transmission rate 1 Gbit/s may be achieved within a cell with a diameter of 0.5 m or less.

Another known wireless infrared architecture is called a multi-spot-diffusing (MSD) architecture and is shown in FIG. 4. Instead of one wide beam transmitter, this architecture utilizes multi-beam transmitters that emit multiple narrow beams, which illuminate small areas (called diffusing spots) on a reflecting surface. Instead of a single element, wide field of view receiver, a composite receiver is used that includes several narrow field of view elements. This MSD type system may be classified as a quasi-directed non-line of sight system, and offers several advantages over to the limited bit-rate/coverage-range of the aforementioned systems. First, the multiple narrow beams emitted by a transmitter of this type of system greatly reduce the path loss associated with free space propagation. Second, the narrow field of view of the receiver elements decrease the amount of ambient light reception, resulting in a higher signal to noise ratio and lower multi-path distortion without using equalization. A receiver may include more than one element in order to receive IR from several diffusing spots, thus ensuring uninterrupted communication in the event that one or more transmitter beams are blocked. Additionally, the ability to receive signals from multiple diffusing spots, also called diversity, allows a system to combine the signals from different receiver elements, using known combining techniques.

Both diffuse and quasi-diffuse systems suffer from a relatively small coverage range. In diffuse configuration, there is a severe increase in the optical path loss as the distance between the receiver and transmitter increases. In a quasi-diffuse configuration, the transmitter has to emit beams at a very small elevation from horizontal. This makes the system sensitive to shadowing of the transmitter by objects in the environment, and may require locating the transmitter above the objects or around the objects to avoid shadowing.

Also, the angle at which the transmitted beams strike a reflecting surface is limited. As mentioned above, both diffuse and quasi-diffuse systems rely on diffuse reflections from reflecting surfaces. At certain angles, a surface has the characteristics of a Lambert surface, that is, an ideal diffusing surface for which the intensity of reflected radiation is independent of direction. However, in a realistic environment, as the angle of incidence increases, the reflection pattern deteriorates from the Lambertian ideal. For example, it has been seen that the reflection pattern of typical surfaces found in an office environment deteriorates from the Lambertian ideal as the angle of incidence increases above approximately 60 degrees, and at around 70 degrees these surfaces exhibit strong specular reflections, that is, where the angle of incidence equals the angle of reflection.

One approach to providing infrared transmissions over a large environment is to use several transmitters, thus forming several communications cells. Apparently, the maximum horizontal dimension D of a single communication cell depends on the distance Hₜ between the transmitter and the reflecting surface (for example, the ceiling of a room). Using an angle of incidence between 60 and 70 degrees, for example 65 degrees, the maximum horizontal dimension D may be expressed as D≈2 Hₜ tan 65 degrees. For instance, cell diameters of 8.6 m and 12.9 m correspond to distances between the transmitter and the ceiling of 2 m and 3 m, respectively. In an MSD configuration, the shape of a cell may be chosen to be square or rectangular, since most rooms have a square or rectangular shape and the room space may be easily divided into square or rectangular communications cells.

### SUMMARY OF THE INVENTION

A wireless infrared system that overcomes the aforementioned disadvantages and other disadvantages of prior art systems by using a multi-beam transmitter and a multi-branch receiver. The transmitter is adapted to emit a number of collimated beams of equal intensity to create a grid of diffusing spots on a surface of the environment, for example, the ceiling of a room. The receiver includes a number of independent, narrow field of view receiving elements aimed at different directions.

Thus, the present invention is able to provide infrared communication indoors using infrared light. The present invention relies on multi-spot diffuse reflections of the optical signal from surfaces in the environment. The optical signal is distributed in form of a regular grid of illuminated small areas on a reflecting surface. In addition, the present invention utilizes a holographic spot-array generator at the transmitter. The optical signal is received through several independent receiving elements, thus creating several independent communication channels. Functionally, the receiver optical front-end consists of an optical concentrator and an optical band-pass filter. The receiver channel optics include a holographic curved mirror and a dielectric filling.

### BRIEF DESCRIPTION OF THE DRAWINGS

FIG. 1 shows an example of a directed link, line of sight infrared system;

FIG. 2 shows an example of a non-directed link, non-line of sight system;

FIG. 3 is a diagram of a non-directed link, line of sight system having a cellular architecture;

FIG. 4 is a diagram of a quasi-directed link, non-line of sight system having a multi-spot diffusing architecture;

FIG. 5 shows an example of a multi-spot diffusing configuration in accordance with the present invention;

FIG. 6 shows the total field of view of a seven branch receiver in accordance with the present invention;

FIG. 7A shows a channel impulse response for a receiving element with a large field of view in a multi-spot diffusing configuration;

FIG. 7B shows a frequency response for a receiving element with a large field of view in a multi-spot diffusing configuration;

FIG. 8A shows a channel impulse response for a receiving element with a small field of view, covering only one diffusing spot in a multi-spot diffusing configuration;

FIG. 8B shows a frequency response for a receiving element with a small field of view, covering only one diffusing spot in a multi-spot diffusing configuration;

FIG. 9A shows a channel impulse response for a receiving element with a small field of view, covering two diffusing spots in a multi-spot diffusing configuration;

FIG. 9B shows a frequency response for a receiving element with a small field of view, covering two diffusing spots in a multi-spot diffusing configuration;

FIG. 10 shows a schematic diagram of transmitter optics adapted to emit a number of collimated beams of equal intensity;

FIG. 11 shows a hologram cell pattern, built up through a gradual choice of pixel by pixel changes from a random initial cell pattern;

FIG. 12A shows a set of desired spot positions and an actual Fourier lattice projected on a plane surface;

FIG. 12B shows a set of Fourier points to be used in designing a grating;

FIG. 13 shows areas on a reflecting surface as seen by receiver branches for different field of view values;

FIG. 14A shows areas on a surface at three different positions covered by a seven branch receiver having a field of view FOV1;

FIG. 14B shows areas on a surface at three different positions covered by a seven branch receiver having a field of view FOV2;

FIG. 15 shows a block diagram of an example of receiver branch optics;

FIG. 16A shows a reflection hologram recorded by two plane waves;

FIG. 16B shows the angular-spectral selectivity of the hologram in FIG. 16A for various parameters;

FIG. 17A shows the types of recording waves for a spherical holographic mirror;

FIG. 17B shows the types of recording waves for a parabolic holographic mirror;

FIG. 18 shows a diagram of a receiver branch optical front end that uses a holographic curved mirror;

FIGS. 19A and 19B show the effective signal area of a photodetector combined with a holographic spherical mirror for different values of detector photosensitive area radius; and

FIGS. 19C and 19D show the effective signal area of a photodetector combined with a holographic parabolic mirror for different values of detector photosensitive area radius.

FIGS. 20A and 20B show the effective figure of merit gain of a photodetector combined with a holographic spherical mirror for different values of detector photosensitive area radius; and

FIGS. 20C and 20D show the effective figure of merit gain of a photodetector combined with a holographic parabolic mirror for different values of detector photosensitive area radius.

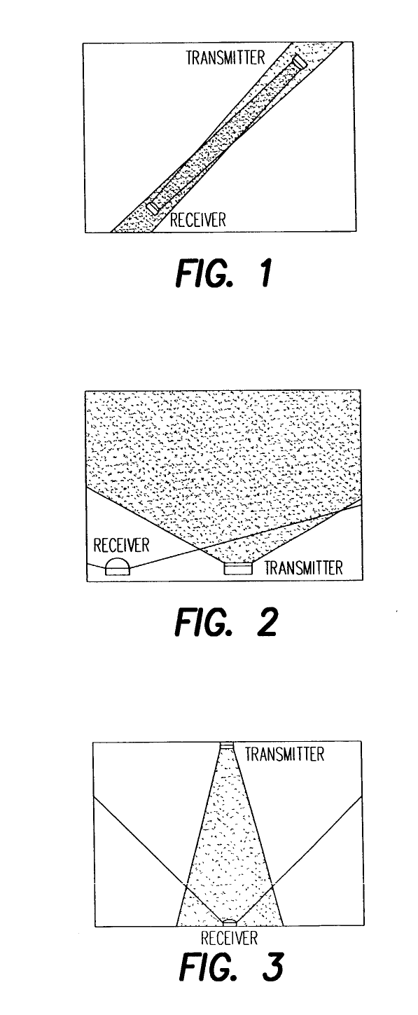

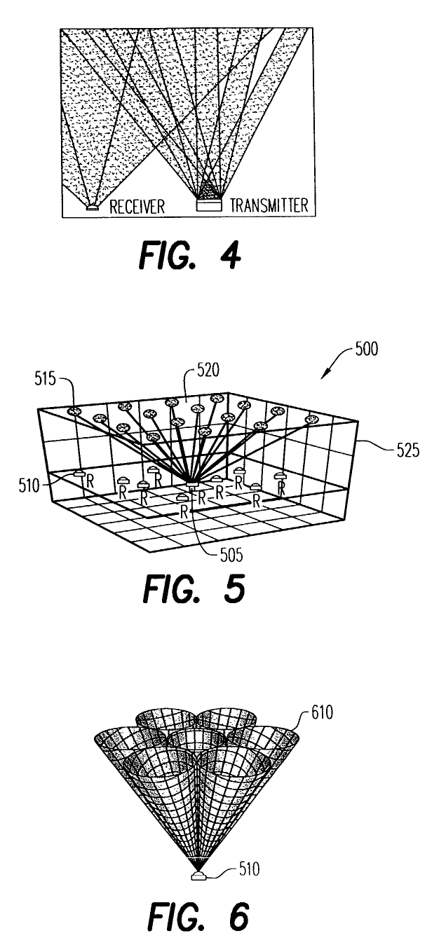

### DETAILED DESCRIPTION OF THE INVENTION

FIG. 5 shows an example of a multi-spot diffusing system 500 in accordance with the present invention. The system 500 includes a transmitter 505 and one or more receivers 510. Transmitter 505 produces a number of collimated beams of equal intensity to create a regular grid of diffusing spots 515 on a surface 520 of the environment 525 in which the multi-spot diffusing system 500 is deployed. As shown in FIG. 6, each receiver 510 includes one or more independent narrow field of view (FOV) receiving elements, also called branches or channels, aimed in different directions. FIG. 6 shows the fields of view 610 of receiver 510 having seven branches.

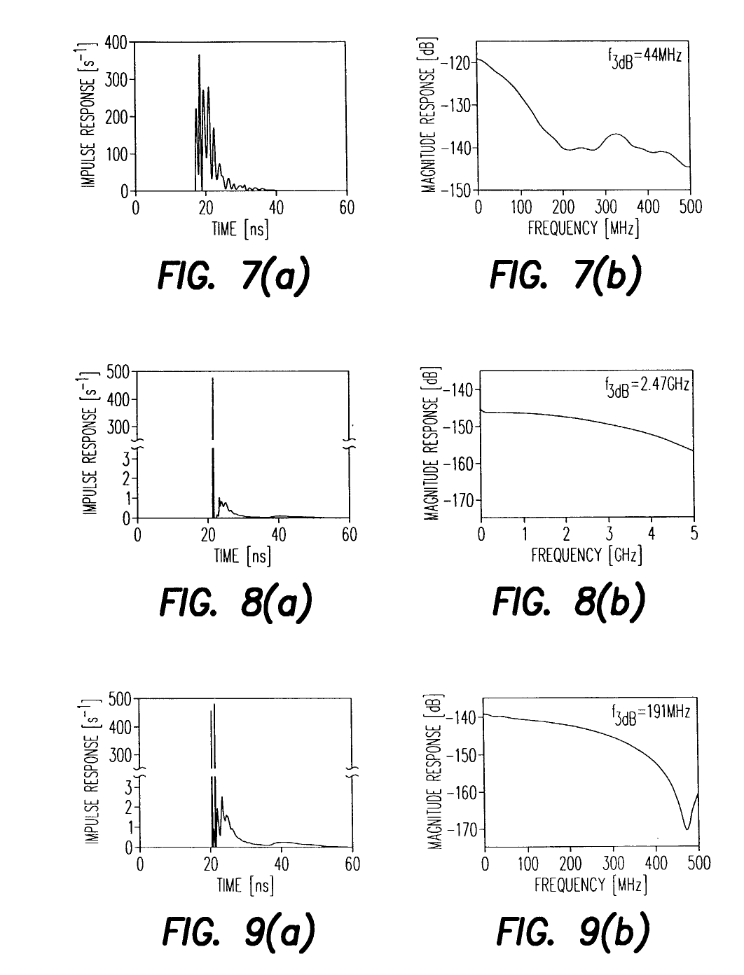

Returning to FIG. 5, each diffusing spot 515 may be considered a line-of-sight light source, at which a narrow FOV channel may be aimed. In this manner, optical power can be received by each channel via a finite number of distinct signal paths where each signal path originates from a diffusing spot 515. The number of signal paths received by each channel then is the number of spots in view of each channel. An example of an impulse response for a channel with a large FOV is shown in FIG. 7A and the corresponding frequency response for the same channel is shown in FIG. 7B. As the FOV of a channel is decreased, a smaller number of diffusing spots are sighted by that channel. FIG. 8 shows an impulse response for a channel that is aimed at only one diffusing spot. A channel having a relatively narrow FOV and having a single diffusion spot in view has been observed to support a relatively high bit transmission rate. Therefore, the FOV of a channel, together with the grid spacing of the diffusing spots determines the potentially achievable transmission rate. For example, as shown in FIG. 9, when a certain channel views two diffusing spots, the 3 dB channel bandwidth is decreased approximately by a factor of ten when compared to the channel viewing a single diffusing spot.

Transmitter Optical Subsystems Description

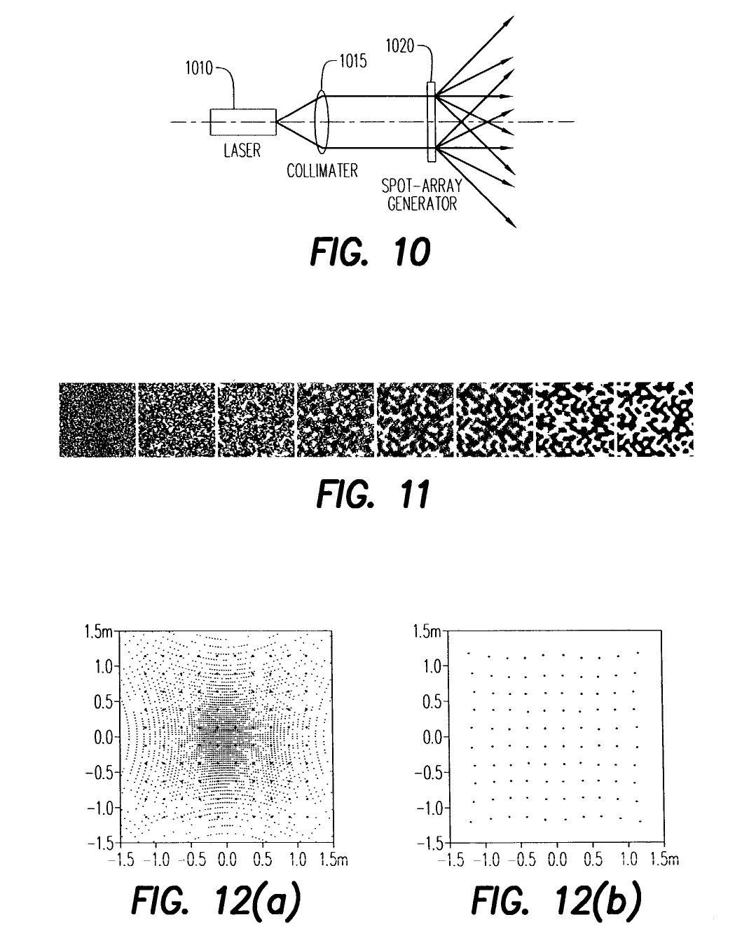

FIG. 10 shows a schematic diagram of transmitter optics adapted to emit a number of collimated beams of equal intensity. The transmitter optics include a light source 1010, in this embodiment a laser diode, collimating optics 1015 and a spot-array generator 1020. Light emitted by light source 1010 is collimated by collimating optics 1015 and is split into multiple equal intensity beams, directed at different angles by spot-array generator 1020. This produces a regular grid of diffusing spots on a surface positioned away from 505. Spot-array generator 1020 may be a holographic optical element, designed as a computer-generated hologram (CGH).

The holographic optical element used for spot-array generator 1020 may be a diffraction grating. The Fourier transform of such a grating, having the form of a large number of periodic repetitions of a single cell pattern, is a lattice of delta functions whose amplitudes and phases are determined by the single cell pattern. The lattice spacing, ΔS, is determined by the cell size, A where:

ΔS=λHₜ/Λ, (1)

where λ is the laser wavelength and Hₜ is the distance between the transmitter and the reflecting surface.

Thus, the design of a spot-array generator is reduced to finding a hologram elementary cell transmission function whose Fourier transform is the desired image. To design the necessary phase grating, an iterative discrete on-axis encoding with simulated annealing may be used. Discrete on-axis encoding is a process where the hologram elementary cell is broken up into a square array of pixels, each imparting a specified phase delay to the incident wave front. Then, the hologram cell pattern is built up through a gradual choice of changes, pixel by pixel, from a random initial cell pattern. FIG. 11 shows an example of a hologram cell pattern at different stages of the iteration procedure. Simulated annealing is a process where a function, defined from the difference between the desired spot pattern and the actual output pattern of the hologram cell pattern is minimized. Typically, the iteration procedure converges after approximately less than 300 iterations. Thus, the actual hologram is a two-dimensional repetition of the elementary cell.

Equation (1) for the lattice spacing of diffusing spots is applicable to small size images only, when there is little difference between the desired spot pattern and the actual output pattern of the hologram cell pattern. In the present application, the holographic element produces an image with a size comparable to the distance between the hologram and an observation plane. As a result, the Fourier lattice resulting from the steps above lies on a curved surface, and when projected on a flat observation plane gives unequal spacing between the Fourier points. This effect is especially noticeable for images having angles above 20 degrees at the holographic grating and is unacceptable for the angles required for the present invention. FIG. 12A shows an actual Fourier lattice projected on a plane surface at a distance of approximately 1 mm from the grating. In order to have equidistantly positioned spots on a plane surface, the desired spot positions may be projected on the actual Fourier lattice and the nearest Fourier points may be used for the grating design as shown in FIG. 12B.

A computer-generated hologram acting as a spot-array generator can be designed to produce any number of beams with prescribed intensities. The choice of the number of beams may be determined by two main factors: first, maximization of the signal power launched through a single diffusing spot; and, second, eye-safety regulations, imposing restrictions on the transmitted power. In principle, the larger the number of diffusing spots, the more optical power can be transmitted in compliance with the eye safety regulations, established by the International Standard IEC 825. In practice, the limit on total optical power depends not only on the total number of transmitted beams, but also on the power contained in a non-diffracted part of the initial laser beam which forms one of the spots of the pattern, also called the central spot. The intensity of the central spot is determined by the hologram design and the accuracy of the fabrication process and usually is 1% of the total transmitted optical power.

To maximize the signal optical power received by each of the channels, each diffusing spot should include as much energy as possible. Assuming the central spot includes 1% of the total transmitted optical power Pₜ, i.e., P_{c} (the power of the central spot)=Pₜ/100, and the computer generated hologram is designed so that the central spot is one of the spots in the array. Then, Pₜ=P_{c}+(N−1) P_{d}=100 P_{c}, where P_{d} is the power contained in each of the diffusing spots excluding the central spot, and N is the total number of spots. Each of the collimated beams emerging from the hologram should contain no more energy than k AEL, where AEL is the accessible emission limit for a point source, established by the International Standard IEC 825, and k=(D_{beam}/Dₐₚₑᵣₜᵤᵣₑ)², where D_{beam} is the beam diameter and Dₐₚₑᵣₜᵤᵣₑ is the aperture diameter applicable to measuring laser irradiance and radiant exposure. Thus, maximum total power is transmitted when the central spot energy equals the accessible emission limit, that is when P_{c}=k AEL. Then, the power contained in each of the other diffusing spots is P_{d}=(99/(N−1))k AEL≦k AEL. Thus, the maximum value for P_{d}, i.e., P_{d}=k AEL, is achieved for a number of spots N=100.

To ensure safe operation conditions, one should consider also the safety regulations for an extended source, that is, a source that includes several beams. This would be applicable where a person looks at the transmitter from a close distance when several beams from the grating may enter the eye. For an array of 10×10 beams and a hologram size of 5 cm×5 cm, at a distance of 10 cm from the transmitter the maximum number of beams that can partly enter an aperture with a diameter of approximately 7 mm is four. These four beams would form four small spots in the eye after focusing by the eye lens. The angle between any two adjacent beams is always much more than 100 mrad. According to IEC-825, this angle allows an extended source to have nine times the permissible power allowed for appoint source and still meet regulations. Thus, the point source regulations impose more severe restrictions on the transmitted optical power.

In order to cover a large area, the transmitter has to emit beams at a very small elevation from a horizontal line as shown in FIG. 5. As mentioned previously, this makes the system sensitive to shadowing by objects in the environment, especially moving objects. This can be avoided locating the transmitter at a height, or in a position to eliminate intrusion of objects into the beams. Also mentioned previously, the angle at which the transmitted beams strike the reflecting surface is limited. The multispot diffusing architecture relies on diffuse reflections from reflecting surfaces, and the cell shape in this type of architecture is typically chosen to be square or rectangular, since most of the environments have a square or rectangular shape and the environment can also be easily divided into square and rectangular communications cells.

For a square communication cell, the diffusing spots grid spacing, AS, is determined by the side of the cell, A, and the total spot number, Nₜ:

ΔS=A/\sqrt{Nₜ}. (3)

In a square cell, the largest horizontal dimension is D, the diagonal side of the square. Then:

ΔS=D/\sqrt{2Nₜ}=2Hₜ tan 65°/\sqrt{2Nₜ}. (4)

Although the grid spacing may be different in different communication cells, the same holographic beam splitter can serve as a spot-array generator regardless of the cell size because the computer generated hologram parameters are independent of the communication cell size A:

Λ=λ\sqrt{Nₜ}/(\sqrt{2}tan 65°). (5)

Receiver Optical Subsystems Description

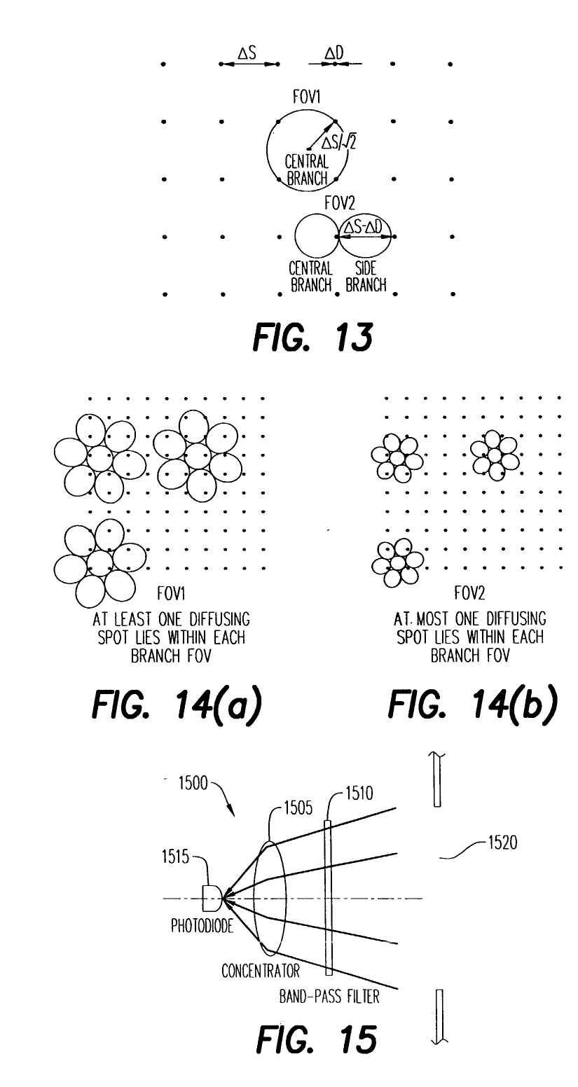

Each receiver channel has an FOV that provides each of the receiver branches with signal power, i.e., at least one diffusing spot lies within the field-of-view of each channel. FIG. 13 shows an example of the areas on the reflecting surface that may be viewed by channels having different fields of view. If ΔS is the diffusing spot grid spacing and R is the radius of the circle area on the reflecting surface seen by a channel, R≧ΔS/√2. Then the receiver channel field-of view becomes:

$$tan ( F O {V}_{1} ) = \frac{R}{{H}_{r}} \geq \frac{Δ S}{\sqrt{2} {H}_{r}} = \frac{λ {H}_{t}}{\sqrt{2} Λ {H}_{r}} , \qquad ( 6 )$$

where Hᵣ is the distance between the receiver and the reflecting surface. Notice that, the limit for the field-of-view is independent of cell size, provided that the receiver and the transmitter are positioned at nearly the same height. When this condition holds, a channel may view more than one diffusing spot.

FIG. 14A shows areas on a surface at three different positions covered by a seven branch receiver having a field of view FOV1, and FIG. 14B shows areas on a surface at three different positions covered by a seven branch receiver having a field of view FOV2. In the ideal state, viewing more that one diffusing spot would cause some deterioration of the channel response. In order to ensure signal reception from only one diffusing spot, the channel field-of-view has to be reduced so that 2R<ΔS−ΔD, where ΔD is the diffusing spot diameter. In a multi spot diffusing configuration, the receiver may include one channel aiming at the reflecting surface and six side channels tilted at an angle that is twice the field-of-view of a single channel as shown in FIG. 6. In order to ensure that none of the receiver channels receives light from more than one spot, the relationship 2R<ΔS−ΔD is applied to all channels. In order to apply this relationship to the central channel, the diameter 2R of the circle area seen by the central branch has to be replaced by the major axis of the ellipse seen by one of the adjacent channels. Thus, the relationship for the receiver channels field-of-view becomes:

$$tan ( 3 {FOV}_{2} ) - tan ( {FOV}_{2} ) \leq \frac{Δ S - Δ D}{{H}_{r}} = \frac{λ {H}_{t}}{Λ {H}_{r}} - \frac{Δ D}{{H}_{r}} . \qquad ( 7 )$$

If ΔD<<ΔS and Hᵣ≈Hₜ, the upper limit for the receiver branch FOV is independent of the communication cell size.

As demonstrated, a larger FOV provides more signal power at the expense of bandwidth, or bit rate transmission. A larger bit rate transmission on comes at the cost of less power efficiency as shown in FIGS. 8 and 9.

The narrow field-of-view of receiver channels in both cases reduces the amount of received signal power, significantly. Although the optical signal power is concentrated in small-area diffusing spots, eye safety requirements limit the power that can be transmitted via a single diffusing spot. The power efficiency of the link may be further improved by an optical concentrator at the receiver. Strong sources of ambient light can be easily rejected using a narrow FOV. However, in some cases a weak, diffused, background ambient source may be much stronger than the optical signal. To improve the optical signal-to-noise ratio, an optical filter that would efficiently reject the optical noise may be employed. Thus functionally, a receiver channel optical front-end 1500 may include an optical concentrator 1505, an optical band-pass filter 1510 and a photodiode 1515 as shown in FIG. 15. The light reaching the entrance aperture 1520 of the optical front-end is filtered by band pass filter 1510 in order to reduce the optical noise and is concentrated by concentrator 1505 in order to increase the irradiance onto the photodiode. Physically, these two functions may also be performed by a a single holographic optical element. The main advantages of holographic optical elements (HOEs) over conventional systems that include a lens, a concentrator and an optical filter are multifunctionality, independence of their physical configuration, insignificant weight, low cost, etc.

The higher spectral selectivity and the lower angular selectivity of reflection holograms compared to transmission holograms make these more suitable for implementing the functions needed for receiver optical front-end 1500.

Volume reflection holograms are also called holographic mirrors, though they do not reflect light as conventional mirrors. They diffract light according to Bragg's law, which establishes a relation between the spacing of the planes of diffraction Λ, the wavelength of light λ and the half-angle θ between the incident and the diffracted beams:

2nΛ sin θ=λ, (8)

where n is the refractive index of the material.

If 0₁ and 0₂ are values of the angles of incidence and diffraction which satisfy the Bragg condition for a wavelength λ, the diffraction efficiency of a lossless reflection hologram is:

$$\begin{matrix}η = {( 1 + \frac{1 - {ξ}^{2} / {μ}^{2}}{{sinh}^{2} \sqrt{{μ}^{2} - {ξ}^{2}}} )}^{- 1} , \\ where μ = \frac{kd}{\sqrt{\vert {c}_{R} {c}_{S} \vert}} , k = \frac{πΔ n}{λ} , {c}_{R} \approx cos {θ}_{1} , {c}_{S} \approx cos {θ}_{2} ,\end{matrix} \qquad ( 9 )$$

ΔN is the amplitude of the refractive index grating, d is the thickness of the hologram,

$$ξ = \frac{d Ω}{2 {c}_{S}}$$

is the off-Bragg parameter that accounts for the deviations from the Bragg condition,

Ω=βΔθ sin(θ₁−θ₂)+Δβ[1−cos(θ₁−θ₂)], (10)

β=2πn/λ is the magnitude of wave vectors satisfying the Bragg condition and Aj3 is the deviation from that value due to a change in the reconstruction beam wavelength, and A0 is the deviation from the Bragg angle 0 at the reconstruction.

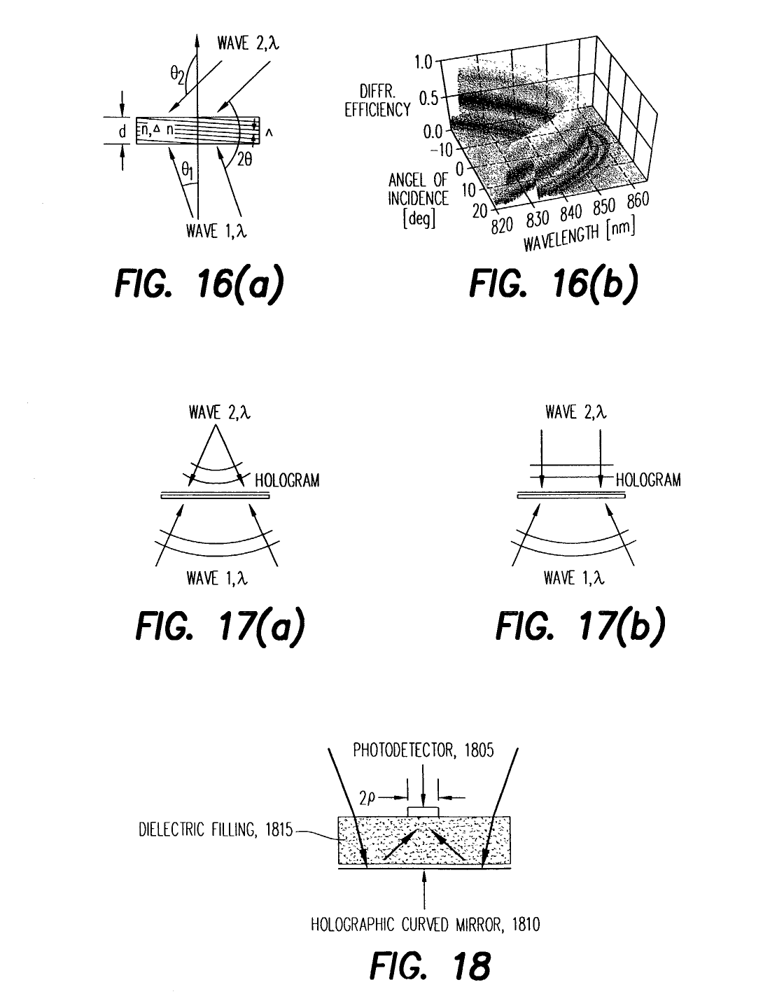

It can be seen from equation 10 that changes in the angle of incidence and wavelength from the recording conditions may be mutually compensatory and at the reconstruction, Bragg condition may be satisfied for angles and wavelengths that differ from those at the recording. This is illustrated in FIG. 16, where the diffraction efficiency dependence on the angle and wavelength is shown for a reflection hologram recorded at 850 nm by two counter-propagating plane waves at normal incidence, i.e., θ₁=0 and θ₂=π.

Since HOE's are independent of their physical configuration, a flat holographic mirror can concentrate light like a conventional curved mirror. The optical properties of the holographic mirrors depend only on the recording geometry. If both recording waves are spherical as shown in FIG. 17A, the resultant hologram behaves as a spherical mirror. If at recording, one plane and one spherical wave are used as shown in FIG. 17B, the hologram has the properties of a parabolic mirror. When combined with a photodetector 1805 in a single system as shown in FIG. 18, the holographic mirror 1810 will perform concentration function as a conventional curved mirror. Furthermore, due to its nature, the holographic mirror 1810 will diffract light from a very narrow spectral range toward the photodetector 1805, thus performing a filtering function, as well. The characteristics of the system, such as field-of-view, concentration ratio, spectral bandwidth, etc., depend on the hologram characteristics, the size and the mutual position of the hologram and the photodiode. The hologram angular sensitivity imposes difficulties in achieving a FOV of greater than a few degrees. This problem can be alleviated by filling the spacing between the holographic mirror 1810 and the photodetector 1805 with a dielectric 1815 having the same refractive index as the hologram medium. Furthermore, it reduces the coupling losses at the photodetector 1805 and facilitates system assembly, as well.

The received signal radiant flux Φₛ is determined by the hologram diffraction efficiency n and depends on the acceptance angle φ and signal wavelength λ:

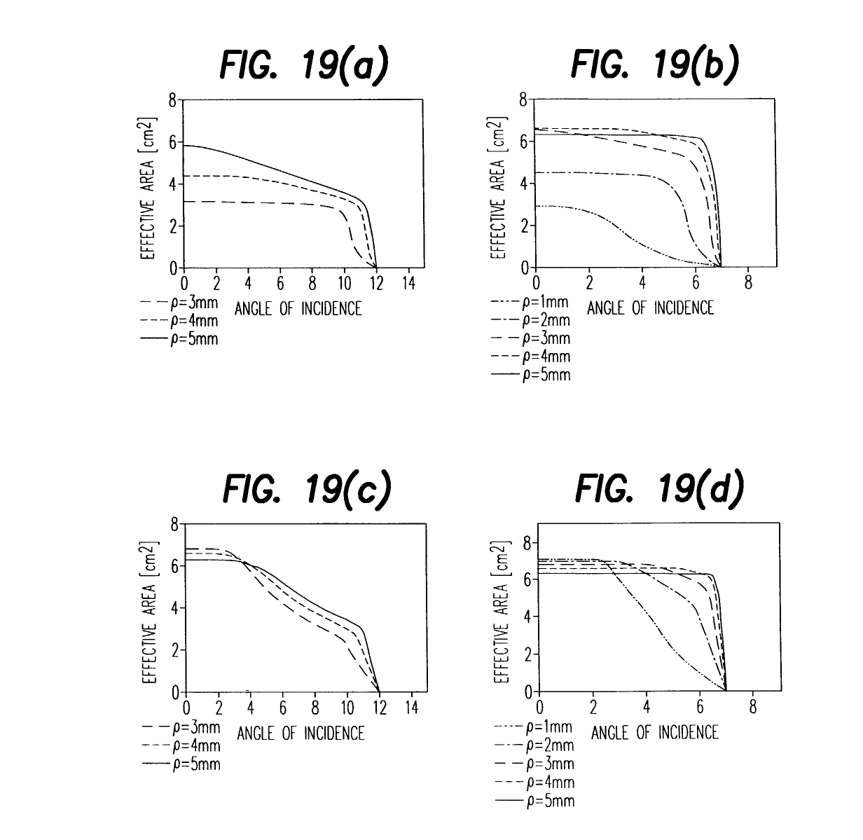

Φ_{S}(φ,λ)=∫_{S}E_{S}θ(φ,dS,λ)cos φdS=E_{S}A_{S,eff}(φ,λ) (1)

where E_{S}[W/cm²] is the signal irradiance and A_{s,eff} [cm²] is the effective signal area of the receiver. The integral is taken over the hologram surface area. The cut-off angle of the receiver is defined to be the angle at which the signal effective area becomes zero. The effective signal area dependence on the angle of incidence is shown in FIGS. 19A-19D for spherical and parabolic holographic mirrors (HSM and HPM) for different photodetector size values. Systems that achieve cut-off angles of 12 and 7 degrees, i.e., complying with the conditions of equations 6 and 7 for the case of Hᵣ≈Hₜ≈2 m, are compared on the graphs. The optical aberrations in HOEs are stronger than in conventional optics due to their angular and spectral selectivity. The systems achieving a larger field-of-view exhibit significant deterioration in signal reception with an increase of the angle of incidence, especially in the case of HPM. Enlarging the photodetector flattens the angular response of the system and initially increases the amount of received optical power in the case of HSM. However, further increase of the detector size for HSM and any increase for HPM causes a reduction of the received optical power at angles close to normal incidence due to the shadowing caused by the photodetector.

In order to be able to judge the quality of the receiver optical front-end, not only its concentrating capability, but its filtering capability has to be considered, as well. A simple criterion on the optical front-end quality is the improvement in the electrical signal-to-noise ratio compared to a bare photodetector. When shot noise is dominant, the signal-to-noise ratio is determined by the received optical signal and the background radiant flux:

$$SNR ( ϕ ) ∝ \frac{{Φ}_{S}^{2} ( ϕ )}{{Φ}_{bg}} . \qquad ( 12 )$$

In the case of HOE serving as an optical front-end, the background radiant flux is:

$${Φ}_{bg} = {\int }_{λ = 0}^{∞} {\int }_{ϕ = 0}^{π / 2} o {\int }_{S} {L}_{bg} η ( ϕ , ⅆ S , λ ) 2 πsinϕcosϕ ⅆ S ⅆ ϕ ⅆ λ = {L}_{bg} {\int }_{λ = 0}^{∞} {( AS )}_{bg , eff} ⅆ λ , \qquad ( 13 )$$

where the spectral background radiance L_{bg} [W/cm²/sr/nm] is taken to be a constant over the spectral range within which the diffraction efficiency n is non-zero and (AS)_{bg,eff} (λ) [cm²sr] is the effective area-solid angle product of the receiver which accounts for the receiver effective area for the ambient light and the effective solid angle within which the ambient light is received.

The electrical signal-to-noise ratio becomes:

$$SNR ( ϕ ) ∝ \frac{{Φ}_{S}^{2} ( ϕ )}{{Φ}_{bg}} = \frac{{E}_{S}^{2}}{{L}_{bg}} \frac{{A}_{S , eff}^{2}}{{\int }_{λ = 0}^{∞} {( AS )}_{bg , eff} ⅆ λ} \qquad ( l4 )$$

and a figure-of-merit can be defined as:

$$M ( ϕ ) = \frac{{A}_{S , eff}^{2}}{{\int }_{λ = 0}^{∞} {( AS )}_{bg , eff} ⅆ λ} . \qquad ( 15 )$$

For a bare photodetector with a photosensitive area of 1 cm² the signal-to-noise ratio and the figure of merit are:

$$\begin{matrix}{SNR}_{det} ( ϕ ) ∝ \frac{{Φ}_{S}^{2} ( ϕ )}{{Φ}_{b g}} = \frac{{E}_{S}^{2}}{{L}_{bg}} \frac{{cos}^{2} ϕ}{4 {πsin}^{2} ( \frac{F O V}{2} ) Δλ} , \\ and & ( 16 ) \\ {M}_{det} ( ϕ ) = \frac{{cos}^{2} ϕ}{4 {πsin}^{2} ( \frac{F O V}{2} ) Δλ} , & ( 17 )\end{matrix}$$

where Δλ is the spectral bandwidth of the photodetector. For simplicity, detector responsivity is taken to be constant over a 200 nm spectral interval centered around the signal wavelength and to be zero out of this range.

Thus, the improvement in the signal-to-noise ratio in dB is, in fact, the figure-of-merit gain:

$${G}_{M} ( ϕ ) = 10 log ( \frac{{A}_{S . eff}^{2}}{{\int }_{λ = 0}^{∞} {( AS )}_{bg , eff} ⅆ λ} \frac{4 {πsin}^{2} ( \frac{FOV}{2} ) 200}{{cos}^{2} ϕ} ) . \qquad ( 18 )$$

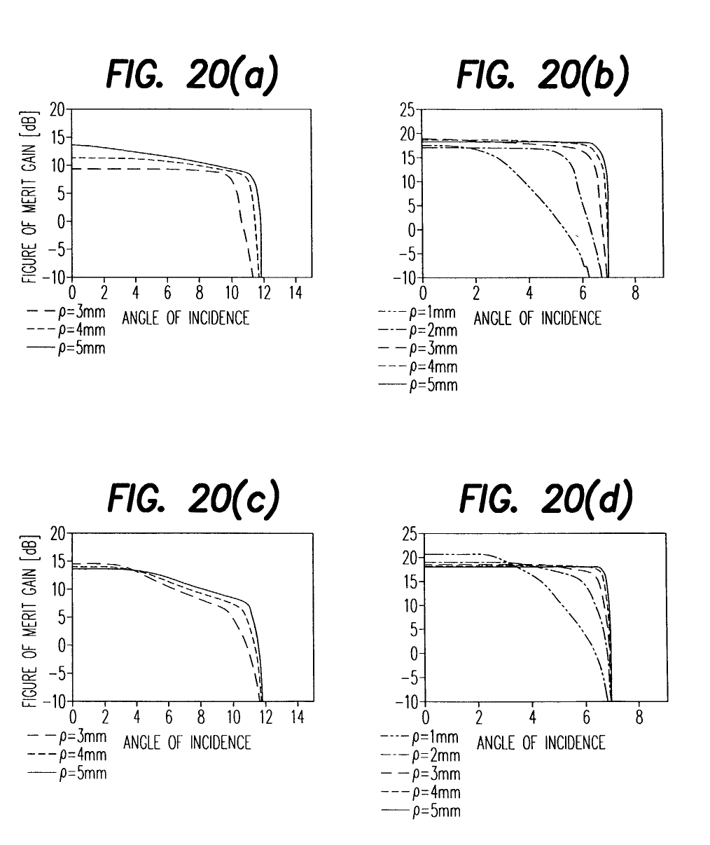

Figure-of-merit gain is presented in FIG. 20 for different size photodetectors when holographic spherical or parabolic mirror is utilized. The angular response of the systems with smaller cut-off angle is closer to the ideal rectangular response and allows the utilization of a smaller size photodetector.

The present invention having been thus described with particular reference to the preferred forms thereof, it will be obvious that various changes and modifications may be made therein without departing from the spirit of the present invention.

What is claimed is:

1. An infrared communications system comprising:
a multi-beam transmitter for producing an array of diffusing spots upon a reflecting surface; and
a receiver comprising a plurality of receiving elements;
wherein each said receiving element has an independent field of view that is in line of sight of at least one of said diffusing spots.

2. The communications system of claim 1, wherein said reflecting surface is a ceiling of a room.

3. The communications system of claim 1, wherein said array is in the form of a regular grid.

4. The communications system of claim 3, wherein said grid of diffusing spots is formed via the emission from said transmitter of a plurality of collimated beams of equal intensity.

5. The communications system of claim 1, wherein said diffusing spots are approximately equidistantly positioned from one another.

6. The communications system of claim 1, wherein the transmitter comprises a light source, collimating optics, and a spot array generator.

7. The communications system of claim 6, wherein the spot array generator is a holographic optical element.

8. The communications system of claim 1, wherein each said receiving element comprises a band-pass filter, a concentrator and a phtodetector.

9. The communications system of claim 1, wherein each said receiving element is aimed in a different direction.

10. The communications system of claim 1, wherein said receiver is a multi-branch receiver.

11. The communications system of claim 1, wherein each said receiving element comprises a curved holographic mirror.

12. A method of infrared communications comprising:
producing an array of diffusing spots upon a reflecting surface; and
receiving signals from at least one of said diffusing spots through a plurality of receiving elements, wherein each said receiving element has an independent field of view that is in line of sight of at least one of said diffusing spots.

13. The method of infrared communication of claim 12, wherein said reflecting surface is a ceiling of a room.

14. The method of infrared communication of claim 12, wherein said array is in the form of a regular grid.

15. The method of infrared communication of claim 14, wherein said grid of diffusing spots is formed via the emission from said transmitter of a plurality of collimated beams of equal intensity.

16. The method of infrared communication of claim 12, wherein said diffusing spots are approximately equidistantly positioned from one another.

17. The method of infrared communication of claim 12, wherein each said receiving element is aimed in a different direction.
